(19) United States
(12) Patent Application Publication
(10) Pub. No.: US 2018/0115145 A1
(43) Pub. Date: Apr. 26, 2018

(54) METHOD AND DEVICE FOR PROTECTING A POWER GRID

(71) Applicant: SAFRAN ELECTRICAL & POWER, Blagnac Cedex (FR)

(72) Inventors: Gilles BENHAMZA, Toulouse (FR); Jérôme GENOULAZ, Seilh (FR); Thibaud LEBRETON, Leguevin (FR)

(21) Appl. No.: 15/560,819

(22) PCT Filed: Mar. 22, 2016
(86) PCT No.: PCT/FR2016/050633

§ 371 Date: Oct. 20, 2017

(30) Foreign Application Priority Data
Mar. 25, 2015 (FR) 1552475

(51) Int. Cl. H02H 1/00; H02H 3/06; H02H 7/22

(52) U.S. Cl. CPC H02H 1/0015; H02H 7/22; H02H 3/066

(57) ABSTRACT

A method for protecting a power grid from an electrical fault, the electrical fault generating a first signal type and a second signal type, the power grid including an electrical power supply and an electrical device between which a contactor is arranged, the contactor being positionable in two states an open state, for which the electrical power supply is not electrically connected to the electrical device; a closed state, for which the electrical power supply is electrically connected to the electrical device; the method including detecting a signal of the first type; placing the contactor in the open state; verifying, during a predetermined time period, whether a signal of the second type appears; if a signal of the second type appears during the period, keeping the contactor in the open state; when no signal of the second type appears during the period, placing the contactor in the closed state.

### TECHNICAL FIELD OF THE INVENTION

The technical field of the invention is that of power grids, and more particularly that of detecting arc faults occurring in power grids.

The invention as such relates to a method and a device for protecting a power grid by detecting arc faults.

### TECHNOLOGICAL BACKGROUND OF THE INVENTION

A power grid makes it possible to convey the electrical power to various electrical loads and can be subject to electric arcs, also referred to as arc faults, of which the most frequent causes are the opening and the closing of contacts, the sectioning of cables, the loss of insulation via friction or ageing, the heating of cables, and the vibrations involving a loss of connection.

Arc faults can in particular cause damage within the power grid or trigger fires. Conventional means of protection (e.g. thermal circuit breakers) do not systematically protect the grid from arc faults and the current means for detecting arcs are not reliable enough to be implemented in fields with demanding constraints, such as aeronautics.

Indeed, such means of protection have a high rate of false alarms. Consequently, the integration thereof, in particular into aeronautical architectures, would result at the end of the chain in systems that are not as safe on the overall due to the untimely trippings, and therefore the operational degradations that they would induce.

Currently, the design of aircraft power grids is governed by installation standards, that set down for example rules for insulation and on the circulation of the electrical cables, which aim to prevent the formation of arc faults. These installation standards unfortunately have limits and the starting of electrical fires remains possible in aircraft.

Until very recently, the detecting of arc faults was therefore not taken into account in the specifications relating to electrical equipment in aeronautics, which was due to the low voltage levels used (115 V AC and 28 V DC).

However, in recent aircraft, many devices that beforehand were hydraulic, mechanical or pneumatic are replaced with electrical devices, which implies an increase in the electrical loads, and leads to an increase in the onboard power. This requirement translates into an increase in the voltage levels which can now reach 230 V AC, and +/−270 V DC.

As such, this increase combined with the constraints imposed by the air environment: drop in pressure linked to the altitude, temperature cycles and variation in the rate of humidity, risk of rendering the existence of arc faults inevitable. Detecting arc faults, in a reliable way, is thus becoming a critical issue. Document WO 2014/001466 describes a device and a method for monitoring a power grid. However, the device and the method described in this document do not make it possible to minimise the damaged that the power grid is subjected to and the risks of fire.

### SUMMARY OF THE INVENTION

This invention aims to resolve the problems that have just been mentioned by proposing a method for determining electric faults that is reliable without however untimely and needlessly interrupting the operation of electrical equipment supplied by a power grid. In the invention, a solution is proposed for reliably detecting an electrical fault occurring in a power grid and rapidly protecting the power grid, its environment, equipment and persons.

To do this, a first aspect of the invention relates to a method for protecting a power grid from an electrical fault, the electrical fault generating a first signal type and a second signal type that is different from the first signal type, the power grid comprising an electrical power supply and an electrical device between which a contactor is arranged, the contactor being able to be placed in two states:
an open state, for which the electrical power supply is not electrically connected to the electrical device;
a closed state, for which the electrical power supply is electrically connected to the electrical device;
   wherein the method comprises the following steps:
detecting a signal of the first type;
placing the contactor in the open state;
verifying, during a predetermined time period referred to as “decided opening time”, whether a signal of the second type appears;
if a signal of the second type appears during the decided opening time, keeping the contactor in the open state;
if no signal of the second type appears during the decided opening time, placing the contactor in the closed state.

The method according to the first aspect of the invention applies very particularly in the case where the electrical fault is an arc fault. “Arc fault” means a visible electric current that is formed between at least two conductors and which propagates in an insulating medium, for example air. An arc fault generates various physical phenomena, of which in particular an electrical signal, an acoustic wave, an electromagnetic disturbance and a light wave.

The method according to the invention makes it possible to cut off the electric current in the power grid as soon as a signal of the first type is detected, this signal being characteristic of an electrical fault. The electric current is then kept cut off or is re-established according to the confirmation or not of the appearance of the electrical fault in the power grid. The confirmation comes from the detecting of a signal of the second type characteristic of the electrical fault.

The method according to the first aspect of the invention may also comprise one or several characteristics from the following considered individually or according to any technically possible combinations:
the power grid further comprises means for detecting a signal of the second type, with the decided opening time being greater than the time required for a signal of the second type to propagate to the means for detecting a signal of the second type. As such a signal of the second type can be detected regardless of the location of the power grid where it is produced;
a signal of the second type propagates in the power grid whether the contactor is in the open state or in the closed state, i.e. independently of the state of the supply of the power grid;
the decided opening time is less than the transparency time of the electrical device. As such, in the case of a false alarm, the electrical device never stops operating;
the method further comprises a step of time correlation between the instant when the contactor is placed in the open state and the instant when a signal of the second type is detected, which makes it possible to discriminate an electrical fault caused by the opening of the contactor from an electrical fault which has occurred in the power grid;
the signals of the first type of signal are electrical signals;
the signals of the second type of signal are acoustic signals.

“Transparency time” means the time during which an electrical device continues to operate although it is no longer connected to the electrical power supply. To do this, capacitors may for example be mounted in the electrical device. The capacitors store electrical energy when the electrical power supply is connected to the electrical device then restore it when the electrical power supply is no longer connected to the electrical device.

For example, the transparency times of equipment intended for aeronautics are 200 ms for equipment operating with AC current, 200 ms for equipment of so-called “Category A” operating with direct current, and 50 ms for equipment of so-called “Category B” operating with direct current.

These transparency times are defined in section 16 of document DO160 which is a normative reference standard for civil aeronautics. Document DO160 defines test procedures and environments for equipment intended for aeronautics.

A second aspect of the invention relates to a device for protecting a power grid from an electrical fault, the electrical fault generating a first signal type and a second signal type that is different from the first signal type, the power grid comprising an electrical power supply and an electrical device, wherein the device comprises:
a first detector able to detect a signal of the first type;
a second detector able to detect if a signal of the second type appears during a predetermined time period referred to as “decided opening time”;
a contactor that can be placed in two states, an open state for which the electrical power supply is not electrically connected to the electrical device, and a closed state for which the electrical power supply is electrically connected to the electrical device;
means for controlling arranged to control the contactor, with the means for controlling being arranged to:
   place the contactor in the open state if the first detector detects a signal of the first type;
   keep the contactor in the open state if the second detector detects a signal of the second type during the decided opening time;
   place the contactor in the closed state if no signal of the second type is detected by the second detector during the decided opening time.

The device according to the second aspect of the invention can also have one or several of the characteristics hereinafter taken individually or according to any of the technically possible combinations.

Preferably, the contactor toggles from the closed state to the open state without generating any electrical fault of a nature to cause the appearance of a signal of the second type. Indeed, if an electrical fault causing the appearance of a signal of the second type were generated during the toggling from the closed state to the open state, this electrical fault could then be detected by the second detector, in such a way that the first detection would be confirmed even though the only electrical fault present in the power grid was created by the toggling of the contactor.

The contactor is for example a static semi-conductor contactor, also referred to as a SSPC contactor for “Solid-State Power Contactor”. The SSPC contactor can be controlled electrically and does not generate any electrical fault, when opening or when closing.

A third aspect of the invention relates to a power grid comprising a device for protecting according to the second aspect of the invention.

### BRIEF DESCRIPTION OF THE FIGURES

The invention and its various applications shall be better understood when reading the following description and when examining the figures that accompany it among which:

FIG. 1 diagrammatically shows a power grid provided with a device for protecting, according to an embodiment of the invention

FIG. 2 shows a functional diagram of a method for protecting a power grid, according to an embodiment of the invention;

FIG. 3 is a chronogram showing the state of a contactor of the device for protecting of FIG. 1, in a first implementation of a preferred embodiment of the invention;

FIG. 4 is a chronogram that shows the state of a contactor of the device for protecting of FIG. 1, in a second implementation of a preferred embodiment of the invention.

The figures are shown only for the purposes of information and do not limit the invention in any way.

For increased clarity, identical or similar elements are marked with identical reference signs in all of the figures.

### DETAILED DESCRIPTION OF AN EMBODIMENT OF THE INVENTION

The invention in particular has for object to propose a method and a device intended to reliably detect the appearance of an electrical fault in a power grid while still cutting off the electric current in the power grid as soon as an electrical fault is likely to have been formed. The invention applies very particularly in the case where the electrical fault is an arc fault.

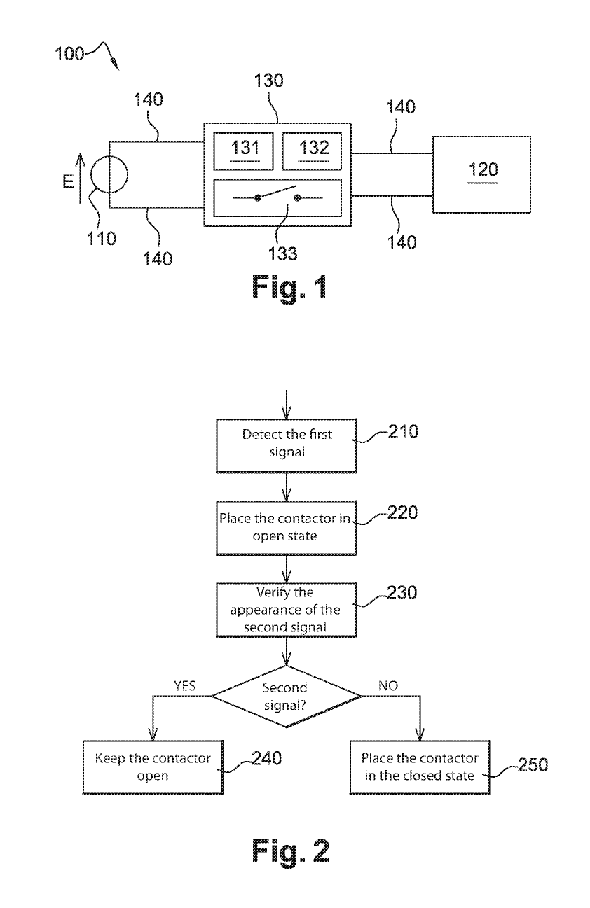

FIGS. 1 and 2 are described jointly.

FIG. 1 diagrammatically shows a power grid 100 that comprises an electrical power supply 110, delivering a supply voltage E, and an electrical device 120. The power grid 100 also comprises a device for protecting 130, according to an embodiment of the invention, connected to the electrical power supply 110 and to the electrical device 120 by electrical wiring 140.

“Electrical wiring” means the electrical cables but also the return current elements, for example the carcass of an aircraft with the conventional construction with an aluminium base, or the return current grid on an aircraft built with a composite material base.

An electrical fault can occur in the power grid 100, which results in the appearance a first signal type and of a second signal type that is different from the first signal type. Consequently, a signal of the first type and a signal of the second type have different propagation speeds, with the signal of the first type propagating faster than the signal of the second type.

According to an embodiment, the signal of the first type may for example be an electrical signal. Such an electrical signal may for example have a propagation speed in copper of 2.73.10⁸ m/s. According to another embodiment, the first signal might for example be an optical signal. Such an optical signal may for example have a propagation speed in air of 3.10⁸ m/s.

The signal of the second type may for example be an acoustic signal. Such an acoustic signal may propagate in the power grid 100 whether or not the latter is supplied. An acoustic signal has for example a propagation speed in copper of 3,350 m/s.

The device for protecting 130 comprises a first detector 131 able to detect the signal and a second detector 132 able to detect the second signal. The device for protecting 130 also comprises a contactor 133 arranged between the electrical power supply 110 and the equipment 120.

The contactor 133 can be controlled and can be placed in two states, an open state and a closed state. When the contactor is in the open state, the electrical power supply 110 is not electrically connected to the electrical device 120, which is then off. When the contactor is in the closed state, the electrical power supply 110 is electrically connected to the electrical device 120, which is then on.

The various steps relating to a method for protecting the power grid 100 according to the invention are for example the following, shown on the functional diagram of FIG. 2.

During a step 210, a signal of the first type that reveals an electrical fault is detected by the first detector 131. The contactor 133 is then placed, during a step 220, in the open state in order to protect the power grid from damage and to prevent the start of a fire.

The signal of the first type is preferably a signal that has a high propagation speed, such as an electrical signal or an optical signal, and arrives almost instantly at the first detector 131. The time required to cut off the electric current is then equivalent to the processing time of the signal of the first type by the first detector 131 plus the response time of the contactor 133, i.e. a few milliseconds. The power grid 100 is as such protected very quickly.

As such, being able to cut off the electric current in a few milliseconds makes it possible to satisfy the requirements of the most stringent standards. For example standard AS 5692, intended for aeronautics, imposes being able to cut off the electric current in less than 8 half-cycles, i.e. less than 10 ms for the conventional 115V operating at a fixed frequency of 400 HZ, and less than 5 ms for the new generation 115 V AC and 230 V AC operating at a variable frequency that can reach 800 HZ.

After having opened the contactor 133 and interrupted the electric current in the power grid 100, this entails confirming that an electrical fault has actually occurred. Indeed, the signal of the first type detected can have an origin other than an electrical fault. In the case for example where the signal of the first type detected is an electrical signal, the latter can be caused by a normal load belonging to the power grid 100 which can have, in certain operating modes, a signature that is similar to that of an electrical signal caused by an electrical fault.

A step of verifying 230 the appearance of a signal of the second type characteristic of the electrical fault by means of the second detector 132 is then carried out. The signal of the second type is tolerant with regards to a cut-off of the electric current in the power grid 100, i.e. it propagates even when the contactor 133 is open and the electric current is interrupted.

In a first embodiment, the contactor 133 toggles from the closed state to the open state without generating any electrical fault, in such a way as to not produce a signal of the second type characteristic of an electrical fault and to not trigger the detection of the signal of the second type. A case of a false alarm would then be considered as a genuine electrical fault. For this, the contactor may therefore be for example a contactor of the SSPC type.

In another embodiment, the contactor 133 can be a conventional mechanical contactor. The conventional mechanical contactor can generate an electrical fault, referred to as “parasitic fault”, when it toggles from one state to the other. In this embodiment, the method for protecting of the power grid 100 further comprises a step of correlation between the moment when the contactor 133 is open and the moment when the signal of the second type produced by the electrical fault is detected. This time combined with the propagation speed of the signal of the second type makes it possible to discriminate a parasitic fault from the electrical fault that is being monitored.

The step of verifying 230 is carried out during a predetermined time period referred to as “decided opening time”. The second detector 132 is advantageously arranged in such a way that the decided opening time is greater than the time required for the second signal to propagate to the second detector 132, regardless of the location of the power grid 100 where the electrical fault occurs.

By considering for example a case for which the farthest distance away from the second detector 132 is 50 m, and for which the second signal is an acoustic signal propagating at 3,350 m/s, the decided opening time is greater than 15 ms.

Two cases are then possible. If a signal of the second type appears during the decided opening time, the electrical fault is confirmed and the contactor 133 is then kept, during a step 240, in the open state.

Otherwise, if no signal of the second type appears during the decided opening time, the electrical fault is actually only a false alarm and the contactor 133 is then placed, during a step 250, in the closed state.

Moreover, the decided opening time is advantageously less than the transparency time of the equipment. For example, for equipment intended for aeronautics of which the minimum transparency time is 50 ms, the decided opening time can be set to 40 ms.

Consequently, in the case of a false alarm, an untimely interruption of the electrical device 120 is avoided. Indeed, from the standpoint of the electrical device 120, if the electric current is re-established before the end of the transparency time, the electric current was never interrupted.

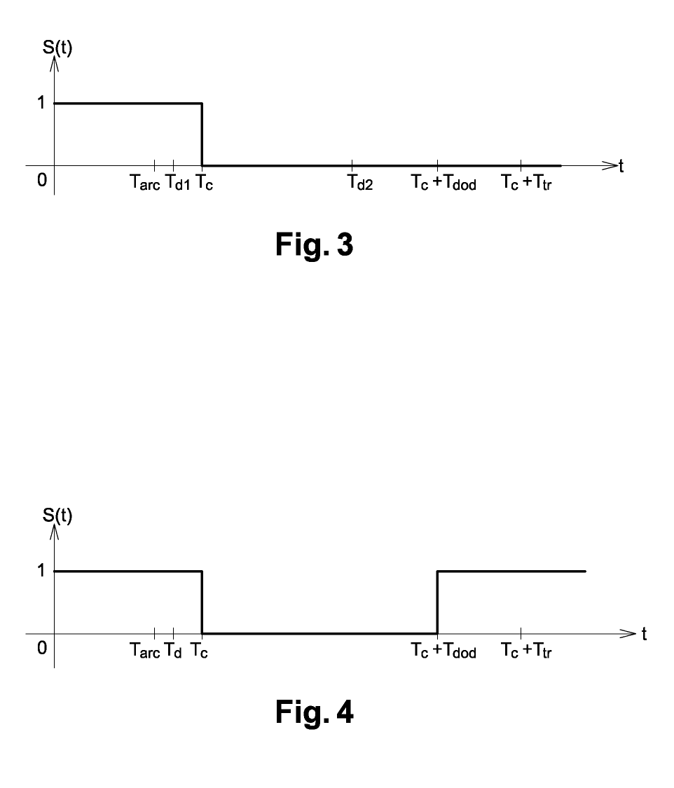

The two examples that follow, corresponding to FIGS. 3 and 4, shall now describe a preferred embodiment of the invention, wherein the electrical fault is an arc fault. The arc fault generates a signal of the first type and a signal of the second type, which are respectively an electrical signal and an acoustic signal.

FIG. 3 is a chronogram showing the state S of the contactor 133 of the device for protecting 130 over time, when an arc fault has actually occurred within the power grid 100. In nominal operation, the contactor 133 is in closed state, represented by a high state of value 1 on the chronogram of FIG. 3, and the electrical device 120 is supplied.

The arc fault occurs at an instant T_{arc} and drives the simultaneous appearances of an electrical signal and of an acoustic signal. The electrical signal arrives at the first detector 131 at an instant T_{d1}. The contactor 133 is then placed in the open state, represented by a low state of value 0 on the chronogram of FIG. 3, at an instant T_{c}.

Then, the acoustic signal arrives at the second detector 132 at an instant T_{d2} before the end of the decided opening time T_{dod}, i.e. before an instant T_{c}+T_{dod}, as such confirming the appearance of the arc fault. The contactor 133 is therefore kept at the open state.

Consequently, after the transparency time Tₜᵣ of the electrical device 120 has elapsed, i.e. at an instant after an instant T_{c}+Tₜᵣ, the electrical device 120 turns off.

FIG. 4 is a chronogram representing the state S of the contactor 133 of the device for protecting 130 over time, when an electrical disturbance, other than an arc fault, occurs within the power grid 100, as such triggering a false alarm. As in the example hereinabove, in nominal operation, the contactor 133 is in the closed state and the electrical device 120 is supplied.

The electrical disturbance occurs at an instant T_{arc} and drives the appearance of an electrical signal that has a signature similar to that of an electrical signal caused by an arc fault. The electrical signal caused by the electrical disturbance arrives at the first detector 131 at an instant T_{d}. The contactor 133 is then placed in the open state at an instant T_{c}.

Then, at the end of the decided opening time T_{dod}, i.e. at an instant T_{c}+T_{dod}, with no acoustic signal having been detected by the second detector 132, the contactor 133 is placed in the closed state.

Consequently, after the transparency time Tₜᵣ of the electrical device 120 has elapsed, i.e. at an instant after an instant T_{c}+Tₜᵣ, the electrical device 120 is still supplied and from its standpoint, nothing has happened.

As such, thanks to the invention, two different methods of detection are combined, one having a short response time in order to protect the power grid 100 very quickly when an electrical fault is detected, and the other having a longer response time in order to confirm the electrical fault, which as such increases reliability. Naturally the invention is not limited to the embodiments described in reference to the figures and alternatives can be considered without leaving the scope of the invention.

1. A method for protecting a power grid from an electrical fault, the electrical fault generating a signal of a first type and a signal of a second type that is different from the signal of the first type, the power grid comprising an electrical power supply and an electrical device between which a contactor is arranged, the contactor being able to be placed in two states:
an open state, for which the electrical power supply is not electrically connected to the electrical device;
a closed state, for which the electrical power supply is electrically connected to the electrical device;
the method comprising:
detecting the signal of the first type;
placing the contactor in the open state;
verifying, during a predetermined time period, whether the signal of the second type appears;
when the signal of the second type appears during the predetermined time period, keeping the contactor in the open state;
when no signal of the second type appears during the predetermined time period, placing the contactor in the closed state.

2. The method as claimed in claim 1, wherein the power grid further comprises a device for detecting a signal of the second type and wherein the predetermined time period is greater than the time required for the signal of the second type to propagate to the the device for detecting the signal of the second type.

3. The method as claimed in claim 1, wherein the predetermined time period is less than a transparency time of the electrical device.

4. The method as claimed in claim 1, further comprising a step of time correlation between an instant when the contactor is placed in the open state and an instant when the signal of the second type is detected.

5. The method as claimed in claim 1, wherein the signal of the first type is an electrical signal.

6. The method as claimed in claim 1, wherein the signal of the second type is an acoustic signal.

7. A device for protecting a power grid from an electrical fault, the electrical fault generating a signal of a first type and a signal of a second type that is different from the signal of the first type, the power grid comprising an electrical power supply and an electrical device, the device comprising:
a first detector able to detect the signal of the first type;
a second detector able to detect the signal of the second type;
a contactor that is positionable in two states, which includes an open state for which the electrical power supply is not electrically connected to the electrical device, and a closed state for which the electrical power supply is electrically connected to the electrical device;
a controller arranged to control the contactor, the controller being arranged to:
place the contactor in the open state when the first detector detects the signal of the first type;
keep the contactor in the open state when the second detector detects the signal of the second type during a predetermined time period;
place the contactor in the closed state when no signal of the second type is detected by the second detector during the decided opening time.

8. The device for protecting according to claim 7, wherein the contactor is a static semi-conductor contactor.

9. A power grid comprising a device for protecting according to claim 7.
